(19) United States
(12) Patent Application Publication
(10) Pub. No.: US 2026/0099969 A1
(43) Pub. Date: Apr. 9, 2026

(54) METHODS AND ELECTRONIC DEVICES FOR ADDING ENTITY OF INTEREST TO CAPTURED IMAGE

(71) Applicant: SAMSUNG ELECTRONICS CO., LTD., Suwon-si (KR)

(72) Inventors: Krishnaditya, Bengaluru (IN); Pragya Pramita Sahu, Bengaluru (IN); Ankit Sharma, Bengaluru (IN); Pinaki Bhaskar, Bengaluru (IN); Aniruddha Bala, Bengaluru (IN); Vignesh Lakshminarayan, Bengaluru (IN)

(73) Assignee: SAMSUNG ELECTRONICS CO., LTD., Suwon -si (KR)

(21) Appl. No.: 19/092,309

(22) Filed: Mar. 27, 2025

Related U.S. Application Data
(63) Continuation of application No. PCT/KR2025/003461, filed on Mar. 17, 2025.

(30) Foreign Application Priority Data
Oct. 7, 2024 (IN) 202441075757

(51) Int. Cl. G06T 11/60; G06V 10/26; G06V 10/75; G06V 10/77; G06V 10/774; G06V 40/10

(52) U.S. Cl. CPC G06T 11/60; G06V 10/26; G06V 10/75; G06V 10/7715; G06V 10/774; G06V 40/10

(57) ABSTRACT

According to an embodiment of the disclosure, a method may include generating one or more masked relevant images by masking-out irrelevant entities from plurality of the relevant images; generating, for each of the one or more target entities, a relative skeletal map using the one or more masked relevant images; generating, for the source image, a feature map comprising information corresponding to physical aspects of the source entities appearing in the source image, and aspects corresponding to a scene identified in the source image; generating an image reconstruction map, based on the feature map of the source image and at least one of the relative skeletal maps; generating, based on the image reconstruction map, a modified source image comprising the one or more target entities.

### CROSS-REFERENCE TO RELATED APPLICATIONS

This application is a continuation application of International Application No. PCT/KR2025/003461, filed on Mar. 17, 2025, which claims priority to Indian Patent Application No. 202441075757, filed on Oct. 7, 2024, in the Indian Patent Office, the disclosures of which are incorporated by reference herein in their entireties.

### BACKGROUND

### 1. Field

The present disclosure relates generally to image capture, and more particularly, to a method and a system for adding an entity of interest to captured images.

### 2. Description of Related Art

Images and/or videos may be preferred sources for users to consume content. For example, the images and/or videos may assist users in learning and/or understanding different types of content. The images and/or videos may also assist in creating and/or storing memories of cherished moments. The images and/or videos may be captured using devices that may have image capturing capabilities such as, but not limited to, a camera, a mobile device having a camera feature, another device (e.g., a personal digital assistant (PDA) or tablet computer) having a camera feature, or the like.

In an exemplary scenario, after a family gathering, a user may realize that a full family picture may not be captured perhaps because of non-availability of certain individuals (e.g., family members) at a particular place and/or time. In another exemplary scenario, the user may realize that a family member (e.g., the user's father) may be missing from some of the pictures, and, therefore, the pictures may seem incomplete. That is, there may be multiple scenarios where it may be desired to add one or more persons in an image that may have been captured without them.

Recently, there may have been related techniques that may attempt to address such scenarios and/or issues. For example, some related techniques may involve post-production editing of the images. That is, a segment of a target person missing from the images may be added manually in the final print and/or via a software application to the digital images before taking the final print. Such related techniques may search for empty spaces (or areas) in an existing image and may only insert the image segment by replacing the empty image area. However, such related techniques may be time consuming, effort-intensive, and/or dependent on human skill and interaction. Further, the image segment added to the image may not match the mood, light, ambience, pose, and/or other aspects of the image. In addition, when adding more than one person, additional empty space may be required in the image, and consequently, a greater portion of the original area of the image (e.g., the background) may be lost.

That is, the related techniques may lack image awareness, as well as, compositional understanding of the image. For example, if the base image has people holding bouquets while standing behind a table, it may not be possible to find a matching segment and the segment image inserted in the image may look like an oddity.

FIGS. 1A to 1C illustrate comparative examples of such related techniques. FIG. 1A illustrates an exemplary scenario of a family holiday picture in which the grandparents may be missing. FIG. 1B illustrates an available segmented image segment of the grandparents. FIG. 1C illustrates an empty space 110 in the image of FIG. 1A that may be identified as a location for the image segment of the grandparents. The segment image of FIG. 1B may be inserted in the image of FIG. 1A to get a final image, as shown in FIG. 2.

Additional related techniques may have been suggested to potentially automate the editing of the image in post-production, which may be time consuming and/or incur a relatively high cost (e.g., resources, computing power, or the like). For example, a related technique may use artificial intelligence and/or machine learning (AI/ML) methods. Related methods involving AI/ML may need relatively high amounts of data and/or resources as such methods may be calculation intensive. That is, the AI/ML methods may need to perform training before implementation, which may need a relatively large amount of sample data for training. Further, even with the use of AI/ML methods, the need for photo-editing applications may not be avoided. In addition to the cost and time that may be needed for such applications, the processing of the images using such applications may introduce errors and/or discrepancies that may affect the structural and/or semantic consistency of other regions of the image being edited.

Image generation methods may be limited in usability as their ability may be limited to adding a specified pixel group (e.g., a user selected image or a generic object image) to a source image, either randomly placed or in an area selected by the user. Image generation pipelines, along with limited usability, may be further restricted by relatively extensive manual intervention.

Thus, there exists a need for further improvements in image capture technology, as the need for improved systems and methods may be constrained by relatively high resource needs and/or a need for manual intervention. Improvements are presented herein. These improvements may also be applicable to other imaging technologies.

### SUMMARY

This summary is provided to introduce a selection of concepts, in a simplified format, that are further described in the detailed description of the disclosure. This summary is neither intended to identify key or essential concepts of the disclosure nor is it intended to determine the scope of the disclosure.

According to an embodiment of the disclosure, a method for adding one or more target entities to a source image may be provided. According to an embodiment of the disclosure, the method may include generating one or more masked relevant images by masking-out irrelevant entities from at least one of the relevant images. According to an embodiment of the disclosure, the at least one of relevant images may comprise at least one of the one or more target entities, or the one or more irrelevant entities not corresponding to source entities appearing in the source image. According to an embodiment of the disclosure, the method may include generating, for each of the one or more target entities, a relative skeletal map using the one or more masked relevant images. According to an embodiment of the disclosure, the relative skeletal map may comprise information pertaining to physical aspects of a corresponding target entity. According to an embodiment of the disclosure, the method may include generating, for the source image, a feature map comprising information corresponding to physical aspects of the source entities appearing in the source image, and aspects corresponding to a scene identified in the source image. According to an embodiment of the disclosure, the method may include generating an image reconstruction map, based on the feature map of the source image and at least one of the relative skeletal maps. According to an embodiment of the disclosure, the method may include generating, based on the image reconstruction map, a modified source image comprising the one or more target entities.

According to an embodiment of the disclosure, an electronic device for adding one or more target entities to a source image may be provided. According to an embodiment of the disclosure, electronic device may include one or more processors comprising processing circuitry; and memory storing instructions. According to an embodiment of the disclosure, the instructions, when executed by the one or more processors individually or collectively, may cause the electronic device to generate one or more masked relevant images by masking-out irrelevant entities from plurality of relevant images. According to an embodiment of the disclosure, the plurality of relevant images may include at least one of the one or more target entities, or the one or more irrelevant entities not corresponding to source entities appearing in the source image. According to an embodiment of the disclosure, the instructions, when executed by the one or more processors individually or collectively, may cause the electronic device to generate, for each of the one or more target entities of interest, a relative skeletal map using the one or more masked relevant images. According to an embodiment of the disclosure, the relative skeletal map may comprise information pertaining to physical aspects of a corresponding target entity. According to an embodiment of the disclosure, the instructions, when executed by the one or more processors individually or collectively, may cause the electronic device to generate, for the source image, an aesthetic feature map comprising information corresponding to physical aspects of the source entities appearing in the source image, and aspects corresponding to a scene identified in the source image. According to an embodiment of the disclosure, the instructions, when executed by the one or more processors individually or collectively, may cause the electronic device to generate, an image reconstruction map based on the aesthetic feature map of the source image, and at least one of the relative skeletal maps. According to an embodiment of the disclosure, the instructions, when executed by the one or more processors individually or collectively, may cause the electronic device to generate, based on the image reconstruction map, a modified source image comprising the one or more target entities.

According to an embodiment of the disclosure, a computer-readable storage medium storing instructions may be provided. According to an embodiment of the disclosure, the computer-readable storage medium storing instructions that, when executed by at least one processor, may cause the at least one processor to generate one or more masked relevant images by masking-out irrelevant entities from plurality of relevant images, According to an embodiment of the disclosure, the plurality of relevant images may comprise at least one of the one or more target entities, or the one or more irrelevant entities not corresponding to source entities appearing in the source image. According to an embodiment of the disclosure, the computer-readable storage medium storing instructions that, when executed by at least one processor, may cause the at least one processor to generate, for each of the one or more target entities of interest, a relative skeletal map using the one or more masked relevant images. According to an embodiment of the disclosure, the relative skeletal map may comprise information pertaining to physical aspects of a corresponding target entity. According to an embodiment of the disclosure, the computer-readable storage medium storing instructions that, when executed by at least one processor, may cause the at least one processor to generate, for the source image, an aesthetic feature map comprising information corresponding to physical aspects of the source entities appearing in the source image, and aspects corresponding to a scene identified in the source image. According to an embodiment of the disclosure, the computer-readable storage medium storing instructions that, when executed by at least one processor, may cause the at least one processor to generate, an image reconstruction map based on the aesthetic feature map of the source image, and at least one of the relative skeletal maps. According to an embodiment of the disclosure, the computer-readable storage medium storing instructions that, when executed by at least one processor, may cause the at least one processor to generate, based on the image reconstruction map, a modified source image comprising the one or more target entities.

To further clarify the advantages and features of the present disclosure, a more particular description of the disclosure is provided by reference to specific embodiments thereof, which are illustrated in the appended drawings. It is appreciated that these drawings depict only typical embodiments of the disclosure and are therefore not to be considered limiting its scope. The disclosure is described and explained with additional specificity and detail with the accompanying drawings.

### BRIEF DESCRIPTION OF THE DRAWINGS

These and other features, aspects, and advantages of the present disclosure may be more apparent when the following description is read with reference to the accompanying drawings in which like characters represent like parts throughout the drawings, wherein:

FIGS. 1A to 1C and FIG. 2 illustrate a comparative example for adding entities in an image, in accordance with an embodiment of the present disclosure;

FIG. 3 illustrates an environment including a system for adding one or more entities of interest to a source image of a real-world scene, in accordance with an embodiment of the present disclosure;

FIG. 4 illustrates the system for adding the one or more entities of interest to the source image, in accordance with an embodiment of the present disclosure;

FIG. 5 illustrates a process flow of the system for adding the one or more entities of interest to the source image, in accordance with an embodiment of the present disclosure;

FIGS. 6A to 6C illustrate a process flow for the generation of a set of masked relevant images, in accordance with an embodiment of the present disclosure;

FIG. 7 illustrates a process flow for generating a relative skeletal map, in accordance with an embodiment of the present disclosure;

FIG. 8 illustrates a process flow for generating an aesthetic feature map for the source image, in accordance with an embodiment of the present disclosure;

FIG. 9 illustrates a process flow for generating an image reconstruction map, in accordance with an embodiment of the present disclosure;

FIG. 10 illustrates a process flow for generating an image using the reconstruction map, in accordance with an embodiment of the present disclosure;

FIG. 11 is a flowchart illustrating a method for adding the one or more entities of interest to the source image, in accordance with an embodiment of the present disclosure;

FIG. 12 illustrates a table describing an exemplary non-exhaustive list of attributes related to the entities and the source image, in accordance with an embodiment of the present disclosure; and

FIG. 13 illustrates a table describing another exemplary non-exhaustive list of aspects related to implicit and explicit features of the real-world scene in the source image, in accordance with an embodiment of the present disclosure.

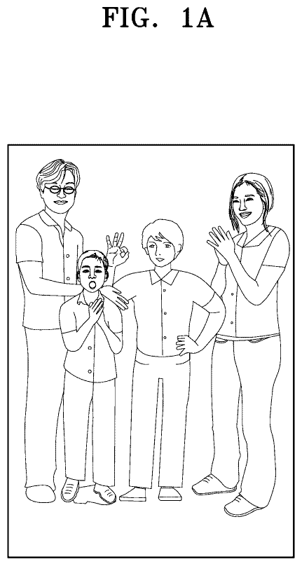

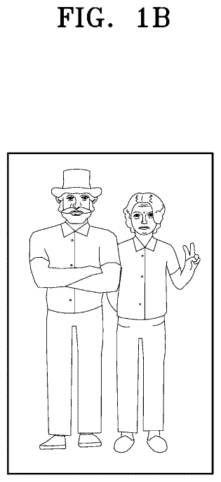

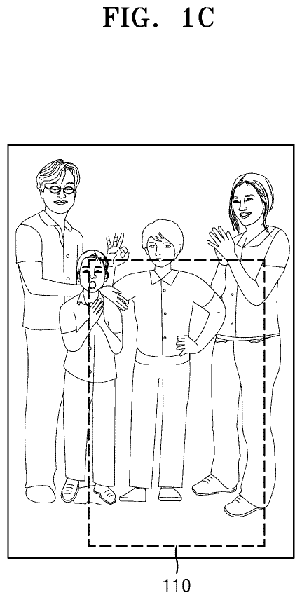

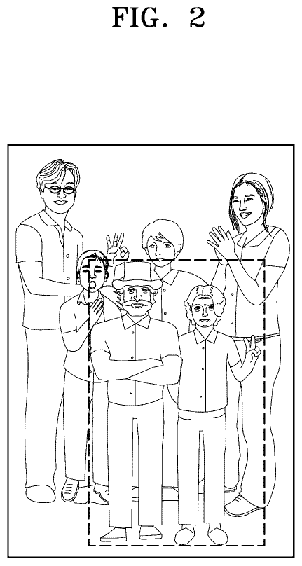

### DETAILED DESCRIPTION

For the purpose of promoting an understanding of the principles of the disclosure, reference is now made to the various embodiments and specific language used to describe the same. It is to be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

Further, skilled artisans may appreciate that elements in the drawings are illustrated for simplicity and may not have necessarily been drawn to scale. For example, the flow charts illustrate the method in terms of the most prominent operations involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that may be readily apparent to those of ordinary skill in the art having the benefit of the description herein.

The term “some” or “one or more” as used herein may refer to “one”, “more than one”, or “all.” Accordingly, the terms “more than one,” “one or more” or “all” may all fall under the definition of “some” or “one or more”. The terms “an embodiment”, “another embodiment”, “some embodiments”, or “in one or more embodiments” may refer to one embodiment or several embodiments, or all embodiments. Accordingly, the term “some embodiments” may refer to one embodiment, or more than one embodiment, or all embodiments.

The terminology and structure employed herein are for describing, teaching, and illuminating some embodiments and their specific features and elements and may not limit, restrict, or reduce the spirit and scope of the claims or their equivalents. The phrase “exemplary”may refer to an example.

That is, any terms used herein such as, but not limited to, “includes,” “comprises,” “has,” “consists,” “have” and grammatical variants thereof may not specify an exact limitation or restriction and may not exclude the possible addition of one or more features or elements, unless otherwise stated, and may not be taken to exclude the possible removal of one or more of the listed features and elements, unless otherwise stated with the limiting language “must comprise” or “needs to include”.

Whether or not a certain feature or element was limited to being used only once, either way, the feature or element may still be referred to as “one or more features”, “one or more elements”, “at least one feature”, or “at least one element.” Furthermore, the use of the terms “one or more” or “at least one” feature or element may not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that the specific order or hierarchy of blocks in the processes/flowcharts disclosed are an illustration of exemplary approaches. Based on design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules, or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

Hereinafter, various embodiments of the present disclosure are described with reference to the accompanying drawings.

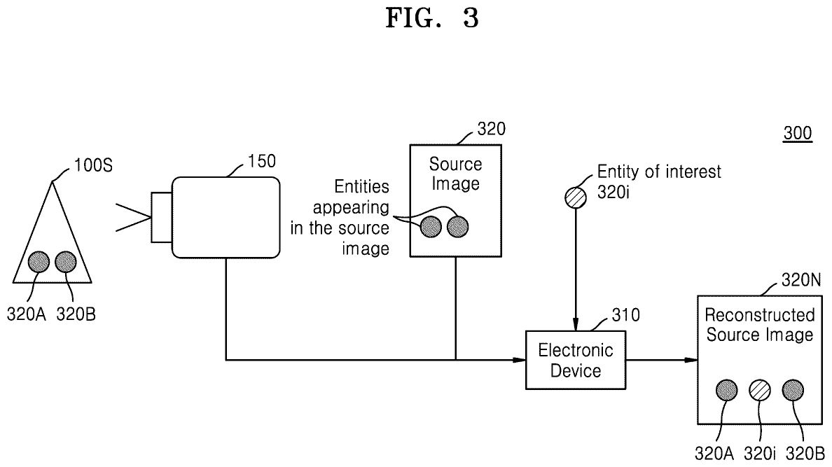

FIG. 3 illustrates an environment 300 including an electronic device 310 for adding one or more entities of interest 320i to a source image 320 of a real-world scene 100S having entities (e.g., a first entity 320A and a second entity 320B), in accordance with an embodiment of the present disclosure. The entity of interest 320i may also be referred to as the target entity. The target entity may be an entity to be added on the source image. The source image 320 may be identified by a camera device 150 (interchangeably referred to herein as the device 150). For example, the source image 320 may be captured by the camera device 150. A source entity may be an entity identified in the source image 320. The first and second entities 320A and 320B may appear in the real-world scene 100S and also in the source image 320. The entity of interest 320i may be a person that may not be present at the scene 100S while the source image 320 is captured. However, the present disclosure is not limited in this regard. For example, the entity of interest 320i may include an inanimate object.

The scene 100S may only include the entities 320A and 320B. However, a user may be interested in adding the entity of interest 320i to the source image 320. In an embodiment, the user may be interested in adding more than one entity of interest 320i to the source image 320 simultaneously. The electronic device 310 may be communicably coupled with the device 150 for adding the one or more entities of interest 320i to the source image 320. For example, as shown in FIG. 3, the electronic device 310 may generate a reconstructed source image 320N that includes the first and second entities 320A and 320B, as well as, the one or more entities of interest 320i.

In various embodiments, the device 150 may be and/or may include a device that may have image capturing capabilities such as, but not limited to, a smartphone, a camera, or any other electronic device having image capturing capabilities and/or having one or more cameras compatible with capturing or recording images, video, or the like of the scene 100S (e.g., the real-world scene), without departing from the scope of the present disclosure.

In various embodiments, the device 150 may include multiple layers (e.g., an application layer, a file system layer, or the like). The application layer may include, for example, a video player application, a gallery application, or a camera application. However, the present disclosure is not limited in this regard, and the application layer may include other applications without departing from the scope of the present disclosure. Further, the file system layer may include, but not be limited to, a file reader, a coder-decoder (CoDec), a frame data, and a file writer. The file reader may be configured to read a video recorded by the application layer. The CoDec may detect and/or check the format of the recorded video (file) and may also check the coder-decoder part of the format of the file. Further, the frame data may be prepared and/or formed by the CoDec for rendering a plurality of frames associated with the video on the display of the device 150.

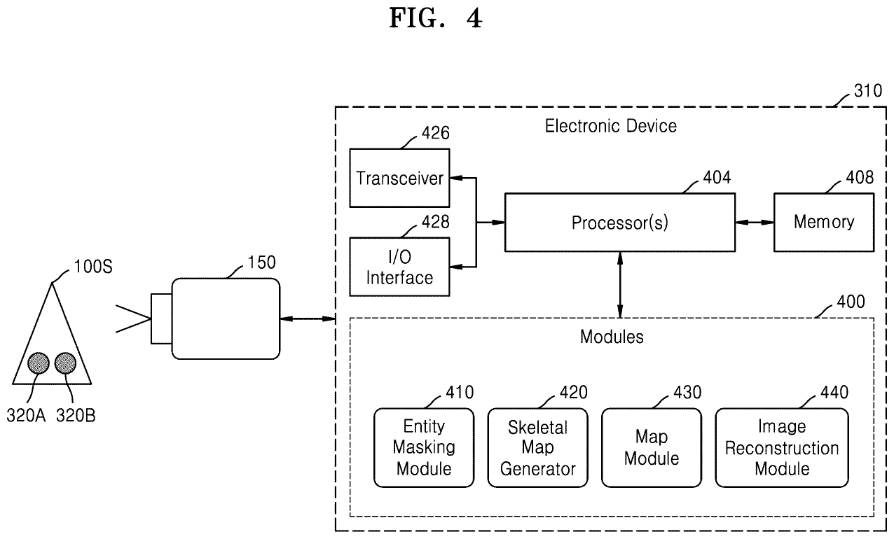

FIG. 4 illustrates the electronic device 310 for adding the one or more entities of interest 320i to the source image 320, in accordance with an embodiment of the present disclosure. The electronic device 310 includes a plurality of modules 400 including an entity masking module 410, a skeletal map generator 420, a map module 430, and an image reconstruction module 440. The entity masking module 410 may be configured to generate a set of masked relevant images by masking-out irrelevant entities from a set of relevant images. The relevant image may be an image including the at least one of target entities or the source entities. The set of relevant images may include at least one of images related to at least one of the entities of interest 320i or the entities of the source entities. The irrelevant entities may be entities not related to at least one or both of the first and second entities 320A and 320B appearing in the source image 320, and the one or more entities of interest 320i.

The skeletal map generator 420 may be configured to generate, for each of the entities of interest 320i, a relative skeletal map using the set of masked relevant images. The relative skeletal map may include information pertaining to physical aspects of the entity of interest 320i. Examples of the physical aspects may include, but not be limited to, height, weight, body-type, pose, posture, or the like. The physical aspects of the entity of interest 320i may be compared with other entities in the set of masked relevant images and, based on the comparison, the relative skeletal map is generated.

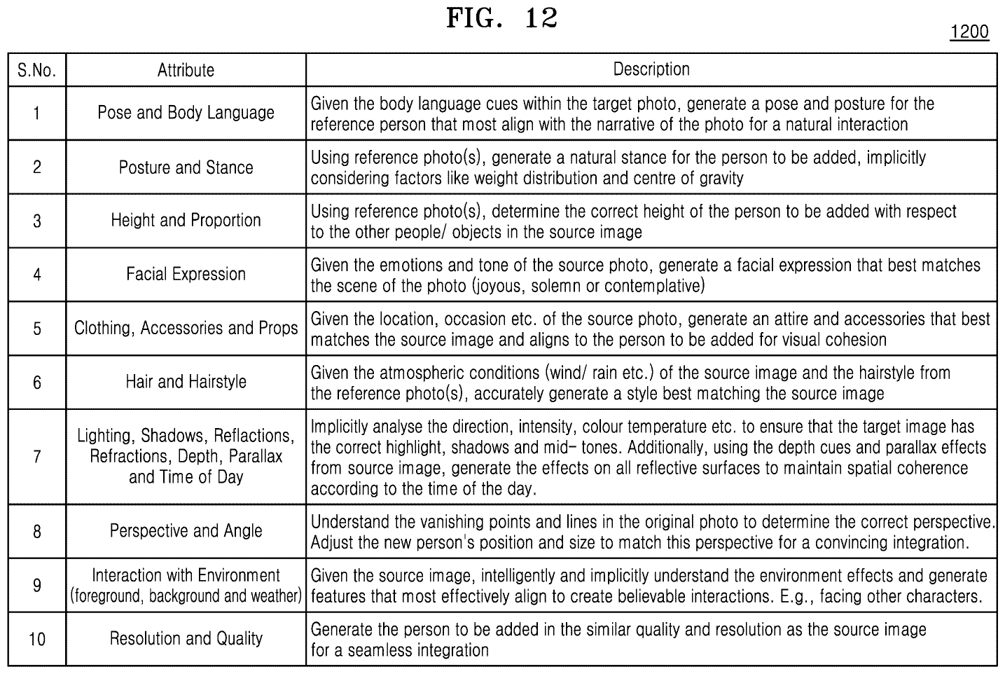

The map module 430 may be configured to generate an aesthetic feature map for the source image 320. The aesthetic feature map may include information related to physical aspects of the source entities appearing in the source image 320 and aspects related to the scene 100S as captured in the source image 320. The physical aspects of the source entities appearing in the source image 320 may include physical aspects such as, but not limited to, height, weight, body-type, pose, posture, or the like, associated with the first and second entities 320A and 320B appearing in the source image 320. Examples of physical aspects are described with reference to table 1200 of FIG. 12.

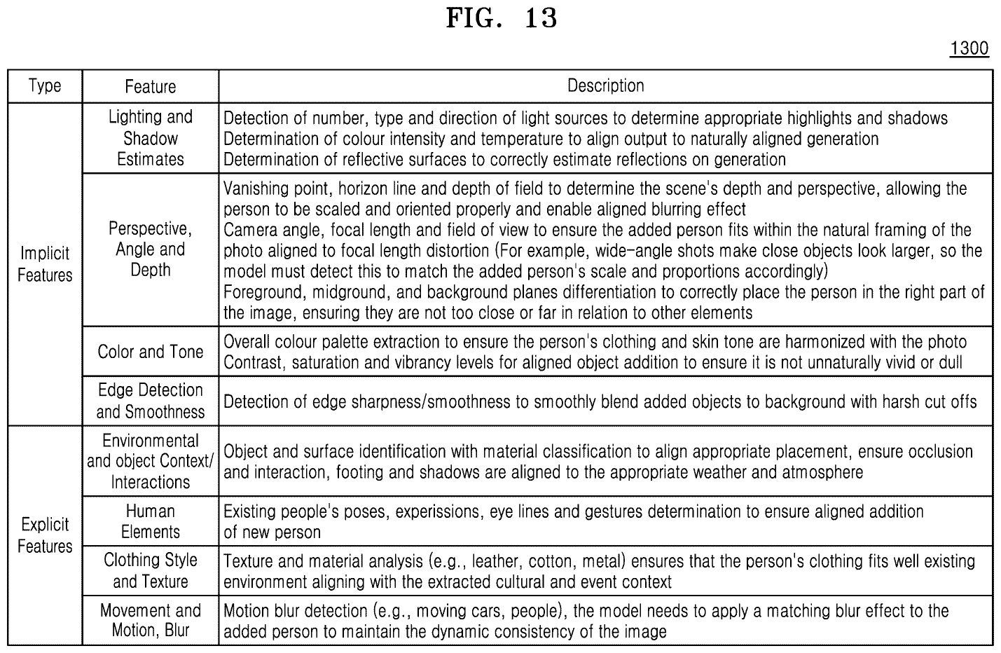

The aspects related to the scene 100S may include implicit features and/or explicit features such as, but not limited to, aspects related to ambience, light, weather, light, shadow, or the like. Examples of implicit features and explicit features are described with reference to table 1300 of FIG. 13.

The image reconstruction module 440 may be configured to generate an image reconstruction map, and to recreate the source image 320 to generate a new image (e.g., the reconstructed source image 320N) that includes the added entity of interest 320i.

The image reconstruction map may be based on the aesthetic feature map of the source image 320 and at least one of the relative skeletal maps. The image reconstruction module 440 may be configured to recreate the source image 320 added with the one or more entities of interest 320i (e.g., the reconstructed source image 320N) based on the generated image reconstruction map. The image reconstruction map may include information for recreating the source image 320. For example, image reconstruction map may include information pertaining to the physical aspects of the entities, including the first and second entities 320A and 320B appearing in the source image 320, and also the physical aspects related to the entity of interest 320i. The image reconstruction map may further include information pertaining to the aspects related to the scene 100S and the composition of the source image 320.

In an embodiment, the electronic device 310 includes a processor 404, a memory 408, a transceiver 426, and an input/output (I/O) interface 428. The processor 404 may be disposed in communication with a communication network via a network interface. In an embodiment, the network interface may be the I/O interface 428. The network interface may connect to the communication network to enable the connection of the electronic device 310 with the device 150. The network interface may employ known communications protocols including, without limitation, direct connect, Ethernet (e.g., twisted pair 10/100/1000 Base T), transmission control protocol/internet protocol (TCP/IP), token ring, Institute of Electrical and Electronics Engineers (IEEE) 802.11a/b/g/n/x (Wireless-Fidelity or Wi-Fi), or the like. The communication network may include, without limitation, a direct interconnection, local area network (LAN), wide area network (WAN), wireless network (e.g., using wireless application protocol (WAP)), the Internet, or the like. Using the network interface and the communication network, the electronic device 310 may communicate with other devices.

In some embodiments, the memory 408 may be communicatively coupled to the processor 404. The memory 408 may be configured to store data and/or instructions that may be executable by the processor 404. In one embodiment, the memory 408 may be provided within the device 150. In another embodiment, the memory 408 may be provided within the electronic device 310 being remote from the device 150. In yet another embodiment, the memory 408 may communicate with the processor 404 via a bus within the electronic device 310. In yet another embodiment, the memory 408 may be located remotely from the processor 404 and may be in communication with the processor 404 via a network. The memory 408 may include, but is not limited to, a non-transitory computer-readable storage media, such as various types of volatile and non-volatile storage media including, but not limited to, random access memory (RAM), read-only memory (ROM), programmable read-only memory (PROM), electrically programmable read-only memory (EPROM), electrically erasable read-only memory (EEPROM), flash memory, magnetic tape or disk, optical media, or the like.

In one example, the memory 408 may include a cache and/or random-access memory for the processor 404. In alternative examples, the memory 408 may be separate from the processor 404, such as a cache memory of a processor, the system memory, or other memory. The memory 408 may be and/or may include an external storage device or database for storing data. The memory 408 may be operable to store instructions executable by the processor 404. The functions, acts, or tasks illustrated in the figures or described in the present disclosure may be performed by the programmed processor 404 for executing the instructions stored in the memory 408. The functions, acts, or tasks may be independent of the particular type of instruction set, storage media, processor, or processing strategy and may be performed by software, hardware, integrated circuits, firmware, micro-code, or the like, operating alone or in combination. Likewise, processing strategies may include multiprocessing, multitasking, parallel processing, or the like. For example, the processor 404 may include two or more processors and/or cores that may execute, individually or collectively, the instructions stored in the memory 408.

At least part of the functions in a device or electronic apparatus provided in the embodiments of the disclosure may be implemented through an AI model, such as, at least one of a plurality of modules of the device or electronic apparatus may be implemented through the AI model. A function associated with AI may be performed through the non-volatile memory, the volatile memory, and the processor.

The processor may include one or more processors. At this time, the one or more processors may be a general purpose processor, such as a central processing unit (CPU), an application processor (AP), or the like, or may be a graphics-only processing unit such as a graphics processing unit (GPU), a visual processing unit (VPU), and/or an AI-dedicated processor such as a neural processing unit (NPU).

The one or more processors control processing of input data in accordance with a predefined operating rule or artificial intelligence (AI) model stored in the non-volatile memory and the volatile memory. The predefined operating rule or artificial intelligence model is provided through training or learning.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Here, being provided through learning means that, by applying a learning algorithm to a plurality of learning data, a predefined operating rule or an AI model of a desired characteristic is made. The learning may be performed in a device or electronic apparatus itself in which AI according to embodiments is performed, and/or may be implemented through a separate server/system.

The AI model may include a plurality of neural network layers. Each layer has a plurality of weight values, and performs a neural network calculation by calculating between the input data of this layer (such as, a calculation result of the previous layer and/or the input data of the AI model) and the plurality of weight values of the current layer. Examples of neural networks include, but are not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), a generative adversarial networks (GAN), and a deep Q-network.

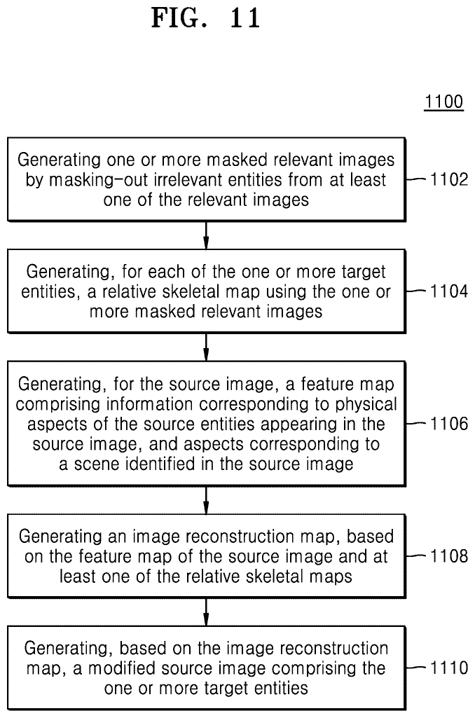

In some embodiments, the plurality of modules 400 may be included within the memory 408. The plurality of modules 400 may include a set of instructions that may be executed to cause the electronic device 310, in particular, the processor 404 of the electronic device 310, to perform any one or more of the methods/processes disclosed herein. The plurality of modules 400 may be configured to perform the operations of the present disclosure using the data stored in the database. For instance, the plurality of modules 400 may be configured to perform the operations disclosed with reference to FIGS. 11 and 12.

In an embodiment, each of the plurality of modules 400 may be and/or may include a hardware unit which may be outside the memory 408. In an embodiment, each of the plurality of modules 400 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the plurality of modules 400. As another example, a processor in combination with a memory may be used to execute one or more instructions to perform the functionality of the plurality of modules 400. Alternatively or additionally, at least a portion of the functionality of the plurality of modules 400 may be incorporated into the processor 404 and/or implemented as instructions to be executed by the processor 404. Further, the memory 408 may include an operating system (OS) for performing one or more tasks of the electronic device 310, as performed by a generic operating system. Each of the modules 400 may be in communication with one another and the processor 404.

In an embodiment, the electronic device 310 may be located in the device 150. In another embodiment, the electronic device 310 is in the form of programmed instructions and may be located at distributed locations such as within the operating system of device 150, installed externally as a software application on the device 150 or in cloud. In another embodiment, the system may be located on a server in communication with the device 150.

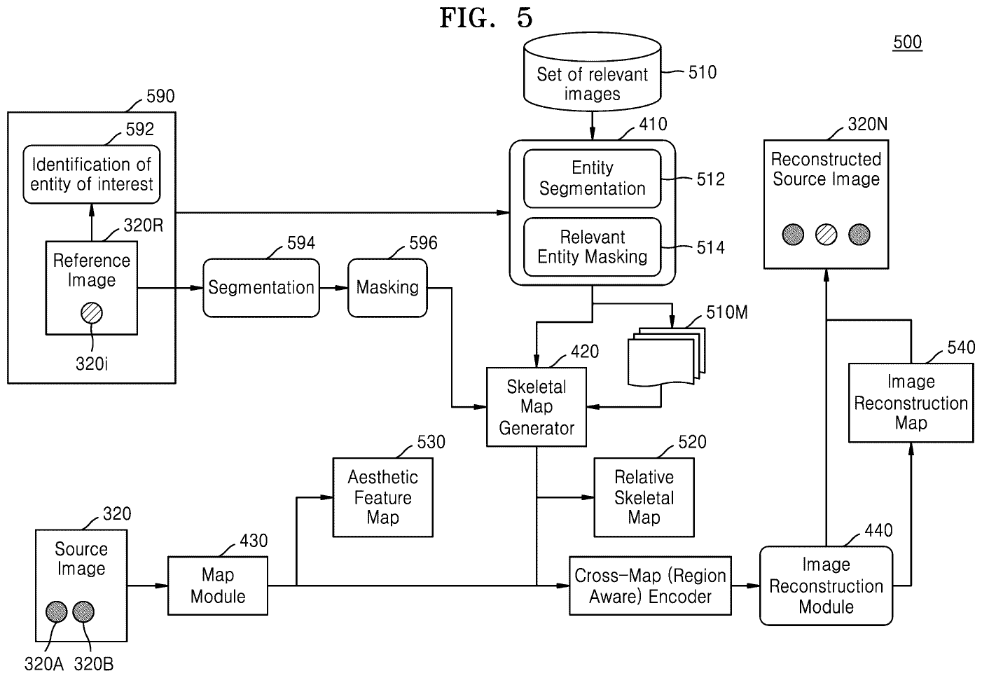

The working and functioning of the plurality of modules 400 of the electronic device 310 are described with reference to FIGS. 5 to 10.

FIG. 5 illustrates a process flow 500 of the electronic device 310 for adding the one or more entities of interest 320i to the source image 320, in accordance with an embodiment of the present disclosure. In an embodiment, the entity masking module 410 includes an entity segmentation module 512 and a relevant entity masking module 514. The entity segmentation module 512 may be configured to perform segmentation of the source image 320 and the reference image 320R. The relevant entity masking module 514 may be configured to mask-out the irrelevant entities from the set of relevant images 510. The image segmentation may be performed by known methods, and as such, a detailed description may be omitted for the sake of brevity. As used herein, image segmentation may be referred to as a computer vision technique that may separate a digital image into discrete groups of pixels (e.g., image segments). Subsequently, the relevant entity masking module 514 may be configured to generate a set of masked relevant images 510M. Upon generation of the set of masked relevant images 510M, the skeletal map generator 420 may be configured to generate, for each of the entities of interest 320i, a relative skeletal map 520 using the set of masked relevant images 510M.

The map module 430 may be configured to generate an aesthetic feature map 530 for the source image 320. The image reconstruction module 440 may be configured to generate an image reconstruction map 540 and to recreate the source image 320 to generate the recreated image 320N with the added entity of interest 320i. In an embodiment, the image reconstruction map 540 may be based on the aesthetic feature map 530 of the source image 320. In an embodiment, the image reconstruction map 540 may be based on at least one of the relative skeletal maps 520. In an embodiment, the image reconstruction map 540 may be based on both the aesthetic feature map 530 of the source image 320 and at least one of the relative skeletal maps 520. The image reconstruction module 440 may be configured to recreate the source image 320 added with the one or more entities of interest 320i based on the image reconstruction map 540.

In an embodiment, the plurality of modules 400 may include an input module 590 configured to receive an input from a user of the device 150. The input may include an aspect related to at least one of the entities of interest 320i. The input may include an aspect related to the source image 320. In an embodiment, the entity masking module 410 may be configured to receive the input from the user of the device 150. The input may include an identification 592 of the entity of interest 320i. The input may include an identification of a reference image 320R. The reference image 320R may include the entity of interest 320i.

The input associated with the entity of interest 320i may be in the form of an image that may include the entity of interest or a command prompt indicating the identification of the entity of interest 320i. However, the present disclosure may not be limited in this regard.

In an embodiment, the entity masking module 410 may be configured to receive the reference image 320R as the input, via the input module 590, from the user of the device 150. In an embodiment, the electronic device 310 may include a segmentation module 594 configured to perform segmentation of the reference image 320R and a masking module 596 configured to mask the entity of interest 320i in the reference image 320R. In an embodiment, the input may be in the form of a prompt such as, but not limited to, a text command, a code, or the like.

In an embodiment, the entity masking module 410 may be configured to retrieve the set of relevant images 510 from all available images. The available images may be the images associated with the device 150 to which the electronic device 310 has access. For example, the available images may be present in the memory 408. Alternatively or additionally, the available images may be present in a cloud accessible to the electronic device 310 via a wireless communication network. The set of relevant images 510 may include relevant images that are the images having an entity related to at least one of the one or more entities of interest 320i and the first and second entities 320A and 320B appearing in the source image 320.

In an embodiment, the skeletal map generator 420 may be configured to compare the physical aspects of the entity of interest 320i with the physical aspects of at least one entity in the set of masked relevant images 510M, and the source image 320. In an embodiment, the skeletal map generator 420 may be configured to compare physical features including a height, a body shape, body size and a face shape of an entity. Based on the comparison, the skeletal map generator 420 may be further configured to determine a set of relative features of the entity of interest 320i with respect to at least one entity (e.g., the first entity 320A or the second entity 320B) appearing in the source image 320.

The number and arrangement of components of the electronic device 310 shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Alternatively or additionally, a set of (one or more) components shown in FIG. 5 may be integrated with each other, and/or may be implemented as an integrated circuit, as software, and/or a combination of circuits and software.

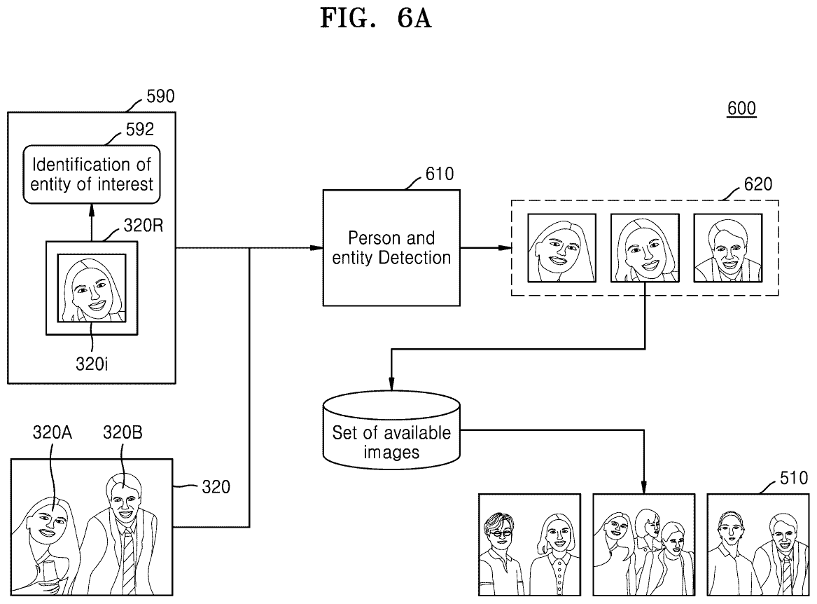

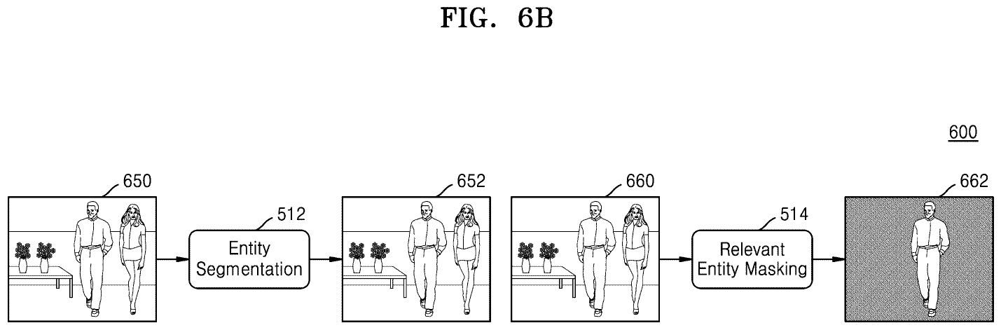

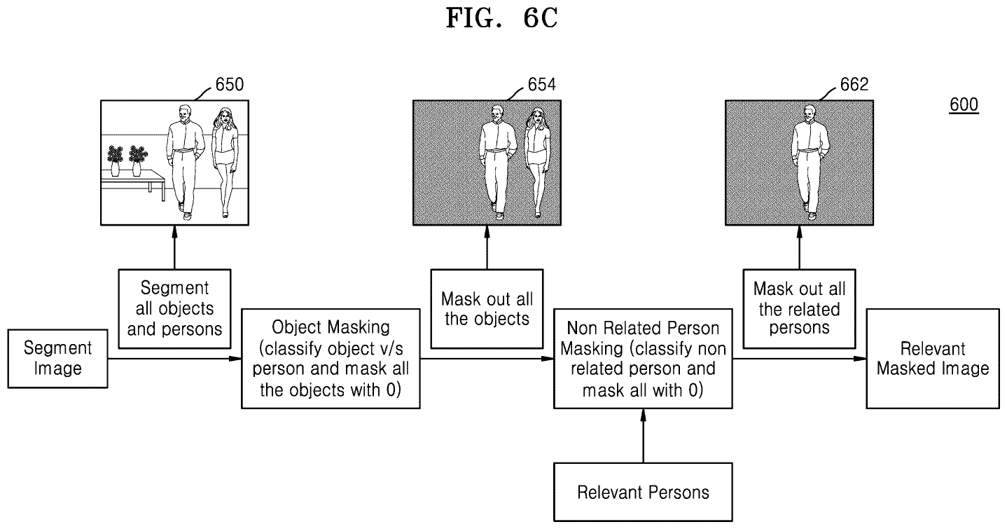

FIGS. 6A to 6C illustrate a process flow 600 for the generation of the set of masked relevant images 510M, in accordance with an embodiment of the present disclosure. At operation 610, the entity masking module 410 may be configured to identify all the entities (e.g., the first entity 320A and the second entity 320B) in the source image 320. In an embodiment, the entity masking module 410 may be further configured to identify the entity of interest 320i based on the input of the user and the reference image 320R. Based on the identification, the entity masking module 410 may be further configured to generate a set of identified entities 620 including the entities appearing in the source image (e.g., the first entity 320A and the second entity 320B) and the entity of interest 320i.

Referring to FIG. 6B, the process flow 600 is illustrated with reference to the entity segmentation module 512 and the relevant entity masking module 514, in accordance with an embodiment of the present disclosure. Image 650 is an exemplary image such as the source image 320, the reference image 320R or the set of relevant images 510. The entity segmentation module 512 may be configured to generate a segmented image 652 of the image 650. Subsequently, the relevant entity masking module 514 may be configured to generate a relevant masked image 662 for an exemplary image 660.

Referring to FIG. 6C, the process flow 600 is illustrated with reference to the segmented image 652 and the relevant masked image 662, in accordance with an embodiment of the present disclosure. The entity segmentation module 512 may be configured to segment all objects and entities appearing in the image 650 to generate the segmented image 652. The relevant entity masking module 514 may be configured to mask all the segmented and irrelevant entities appearing in the segmented image 652 to generate the non-related person masked image 654. The relevant entity masking module 514 may be further configured to mask the persons that do not match the relevant persons to generate the relevant masked image 662, which only contain the relevant persons included in the segmented image 652. In an embodiment, the entity masking module 410 may use independently pre-trained machine learning (ML) models for classification of objects and entities and for masking irrelevant entities. For example, the entity masking module 410 may use pre-configured data sets for training such as, but not limited to, open source datasets, common objects in context (COCO), masked face recognition (MFR2), FaceMask, or the like.

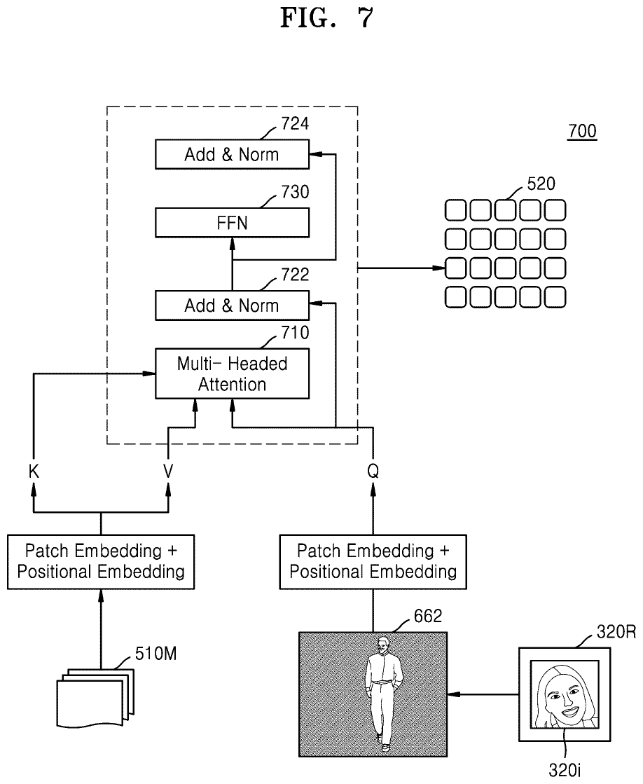

FIG. 7 illustrates a process flow 700 for generating the relative skeletal map 520, in accordance with an embodiment of the present disclosure. In an embodiment, the skeletal map generator 420 may use pre-trained ML models for performing the comparison and determining of the set of relative features. In an embodiment, the skeletal map generator 420 may include a multi headed attention module 710, add and normalization modules (e.g., a first add and norm module 722 and a second add and norm module 724), feed forward network (FFN) module 730, and patch embedding and positional embedding modules (e.g., a first patch embedding and positional embedding module 730A and a second patch embedding and positional embedding module 730B). The skeletal map generator 420 may be configured to generate the relative skeletal map 520 using the set of masked relevant images 510M and the relevant masked image 662 corresponding to the reference image 320R. The skeletal map generator 420 may be configured to detect the relative features of the entity of interest 320i with respect to entities in the images in the set of masked relevant images 510M.

According to the embodiment, the relative features of the target entity with respect to entities in the images in the set of masked relevant images 510M may be detected by performing the multi-headed attention 710. The patch embedding of the entities in the set of masked relevant images 510M and the positional embedding of the entities in the set of masked relevant images 510M may be used for the keys of the multi-headed attention 710. The patch embedding of the entities in the set of masked relevant images 510M and the positional embedding of the entities in the set of masked relevant images 510M may be used for values of the multi-headed attention 710. According to an embodiment, the patch embedding of the target entity and the positional embedding of the target entity may be used for the query of the multi-headed attention 710. The patch embedding of the target entity and the positional embedding of the target entity may be obtained based on the user input. For example, patch embedding of the target entity and the positional embedding of the target entity may be obtained by masking the target entity from reference image 320 R. The skeletal map generator 420 is configured to generate the relative skeleton map 520 for the entity of interest 320i by attending to the masked image 662 of the entity of interest 320i and the masked images in the set of masked relevant images 510M.

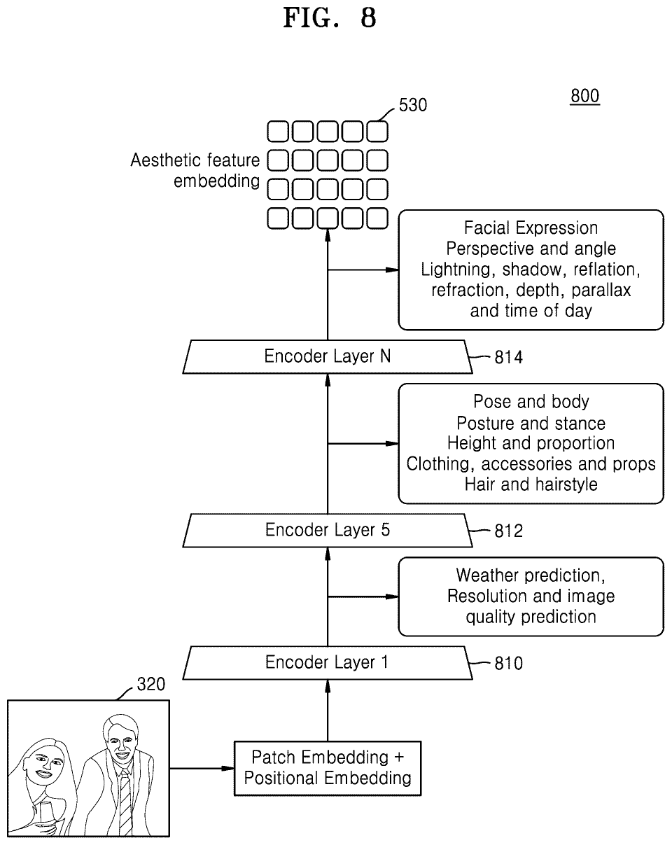

FIG. 8 illustrates a process flow 800 for generating the aesthetic feature map 530 for the source image 320, in accordance with an embodiment of the present disclosure. In an embodiment, the map module 430 may be configured to determine using ML models, the physical aspects of the entities in the source image 320 and features related to a composition of the source image 320. The aesthetic feature map 530 may include information related to the physical aspects of the first and second entities 320A and 320B appearing in the source image 320, and aspects related to the scene 100S as captured by the device 150 in the source image 320. The process flow 800 may include a plurality of encoder layers (e.g., a first encoder layer Layer1 810, to a fifth encoder layer Layer5 812, to an N-th encoder layer Layer N 814, where N is a positive integer greater than one (1)). Each encoder layer of the plurality of first to N-th encoder layers 810 to 814 may be configured to predict at least some of the physical aspects of the first and second entities 320A and 320B appearing in the source image 320, and the aspects related to the scene 100S. For example, the first encoder layer Layer1 810 may predict at least one of the weather, resolution, and image quality aspects of the source image 320. Similarly, the fifth encoder layer Layer5 812 may be configured to predict the physical aspects associated with the first and second entities 320A and 320B appearing in the source image 320 such as, but not limited to, pose, body posture, stance, height, clothing, accessories, props, or the like. Still further, the N-th encoder layer Layer N 814 may be configured to predict the physical aspects associated with the first and second entities 320A and 320B appearing in the source image 320 such as, but not limited to, facial expression, perspective, angle, lighting, shadow, reflection, parallax, time of the day, or the like.

The aesthetic feature map 530 may include a pipeline to analyze and predict multiple aspects associated with the source image 320 that may need to be considered for adding the entity of interest 320i to the source image 320. The process flow 800 achieves training of a multi-headed, self-attention based encoder including the plurality of first to N-th encoder layers 810 to 814 to generate the aesthetic feature map 530. The training may be performed in steps at each encoder layer of the plurality of first to N-th encoder layers 810 to 814 by using an intermediate layer output from the plurality of first to N-th encoder layers 810 to 814.

In an embodiment, sparse features such as, but not limited to, the aspects related to weather and atmospheric details may be learnt from an initial set of layers of the plurality of first to N-th encoder layers 810 to 814. Similarly, finer details such as, but not limited to, the aspects related to occasion prediction, expression based sentiments, or the like may be learnt from another set of layers of the plurality of first to N-th encoder layers 810 to 814.

In an embodiment, the electronic device 310 may further include a trainer ML model. The trainer ML may be pre-trained using a set of annotated images and marked corresponding target features. The electronic device 310 may further include a training module configured to train the ML models to determine the physical aspects of the entities in the source image 320 and to determine the features related to the composition of the source image 320. The training module may be configured to train the ML models using an intermediate layer output of the pre-trained trainer ML model. In an embodiment, the plurality of first to N-th encoder layers 810 to 814 may be pre-trained using a set of annotated images with features such as, but not limited to, the aspects related to the source image 320.

The training module may be further configured to determine features of the entities in the source image 320. The determined features may include, but not be limited to, a facial expression, a pose, a posture, a hair style, an attire of the entities in the source image 320, or the like. The training module may be further configured to determine the features related to a weather, a lighting, a theme, or the like, of the source image 320.

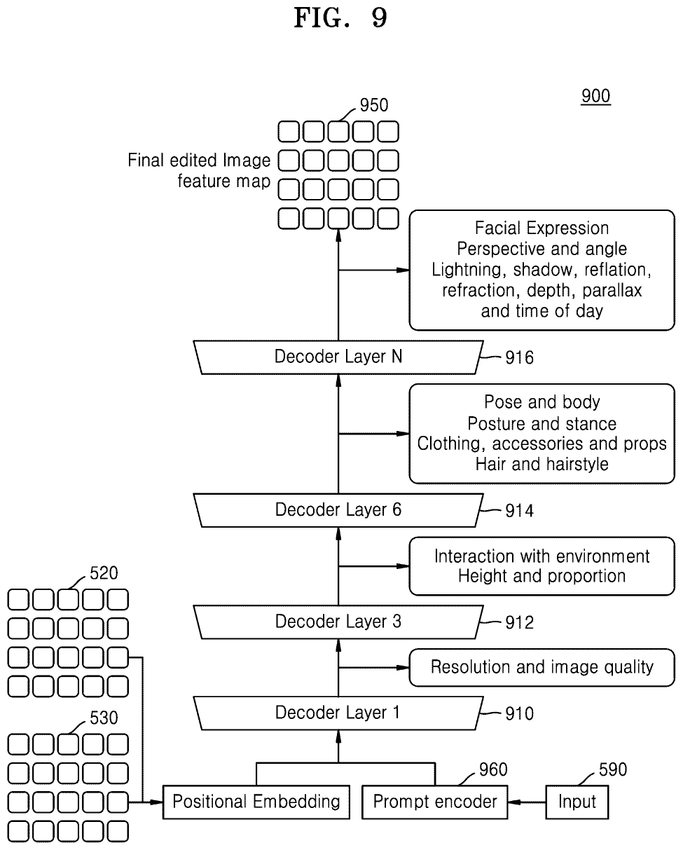

FIG. 9 illustrates a process flow 900 for generating the image reconstruction map 540, in accordance with an embodiment of the present disclosure. The process flow 900 may include a plurality of decoder layers (e.g., a first decoder layer Layer 1 910, to a third decoder layer Layer 2 912, to a sixth decoder layer Layer 6 914, to an N-th decoder layer Layer N 916) for generating an image reconstruction map 950. Each decoder layer of the plurality of first to N-th decoder layers 910 to 916 may be configured to predict features for the image 320N to be generated based on the aesthetic feature map 530 and at least one of the relative skeletal maps 520. For example, the first decoder layer Layer 1 910 may predict features such as, but not limited to, resolution and image quality for the image 320N. Similarly, the third decoder layer Layer 3 912 may be configured to predict the physical aspects associated with the first and second entities 320A and 320B and the entity of interest 320i such as, but not limited to, interaction with the environment, height and proportion, or the like. Still further, the sixth decoder layer Layer 6 914 may be configured to predict the physical aspects associated with the first and second entities 320A and 320B and the entity of interest 320i such as, but not limited to, pose and body-type, posture, stance, clothing, or the like. The N-th decoder layer Layer N 916 may be configured to predict the physical aspects associated with the first and second entities 320A and 320B and the entity of interest 320i such as, but not limited to, facial expression, perspective, angle, or the like.

In an embodiment, the electronic device 310 may include a prompt encoder 960. The input from the input module 590 may be provided to the prompt encoder 960. The input may relate to information related to a desired location of the entity of interest 320i in the source image 320. The plurality of first to N-th decoder layers 910 to 916 may use the information related to the desired location to generate the image reconstruction map 950.

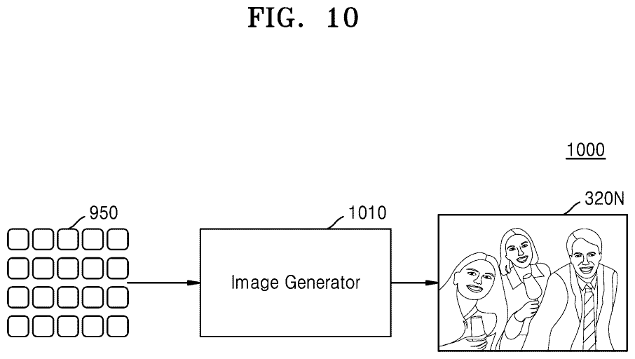

FIG. 10 illustrates a process flow 1000 for generating the image 320N using the reconstruction map 950, in accordance with an embodiment of the present disclosure. In an embodiment, the electronic device 310 may include an image generator 1010 configured to recreate the source image 320 to generate the recreated image 320N with the added entity of interest 320i. The image generator 1010 may generate the image 320N based on the reconstruction map 950. In an embodiment, the image generator 1010 may use generative adversarial networks (GANs) and/or diffusion models to generate the image 320N. However, the present disclosure is not limited in this regard.

In an embodiment, the image reconstruction module 440 may be configured to determine a location in the source image 320 for adding the entities of interest 320i. The determination may be based on at least one of the relative skeletal map 520 and the aesthetic feature map 530 of the source image 320. The determination may be based on the input of the user of the device 150.

In an embodiment, the entity masking module 410 may be configured, using ML models, to identify and/or mask the irrelevant entities in the set of relevant images 510. In an embodiment, the entity masking module 410 may be further configured to train the ML models using sample data to identify and/or mask the irrelevant entities in the set of relevant images 510.

FIG. 11 is a flowchart illustrating a method 1100 for adding the one or more entities of interest 320i to the source image 320, in accordance with an embodiment of the present disclosure.

Referring to FIGS. 3 to 10 together, the method 1100 may be performed by the device 150 such as, but not limited to, a camera device having image capturing capabilities (e.g., a camcorder), a mobile device, a tablet computer with similar capabilities, or the like, based on instructions retrieved from non-transitory computer-readable media. A computer-readable media may include machine-executable or computer-executable instructions to perform all or portions of the described method. The computer-readable media may be, for example, digital memories, magnetic storage media, such as magnetic disks and magnetic tapes, hard drives, or optically readable data storage media.

The method 1100 includes a series of operations shown at operation 1102 through operation 1110 of FIG. 11. The method 1100 may be performed by the electronic device 310 in conjunction with one or more modules 400, the details of which are explained in conjunction with FIGS. 3 to 10, and the same are not repeated here for the sake of brevity. The method 1100 begins at operation 1102.

At operation 1102, the method 1100 includes generating one or more masked relevant images by masking-out irrelevant entities from at least one of the relevant images. The method may include generating, from the set of relevant images, the set of masked relevant images 510 by masking-out irrelevant entities. The set of relevant images may include images related to at least one of the entities of interest 320i. The irrelevant entities may be entities not related to entities appearing in the source image 320 and the entities of interest 320i. At operation 1102, the method 1100 further includes retrieving the set of relevant images from all available images. The relevant images are the images which are related to at least one entity of the one or more entities of interest 320i and the first and second entities 320A and 320B appearing in the source image 320. In an embodiment, the method 1100 further includes receiving an input from a user of the device 150. The input may include an identification of the entity of interest 320i. The input may include an identification of the reference image 320R. In an embodiment, the method 1100 includes receiving the reference image 320R as the input from the user.

In an embodiment, at operation 1102 the method 1100 further includes using ML models to identify and mask the irrelevant entities in the set of relevant images to generate the set of masked relevant images 510M. In an embodiment, at operation 1102 the method 1100 further includes training the ML models to identify and mask the irrelevant entities in the set of relevant images using sample data.

In an embodiment, the method 1100 includes receiving an aspect related to at least one of the entities of interest 320i and an aspect related to the source image 320 as the input from the user. Examples of the aspects related to the entities of interest 320i may include aspects qualifying the entities of interest 320i such as, but not limited to, clothing, posture, standing, or the like. Similarly, examples of the aspects related to the source image 320 may include aspects related to the location of addition of the entity of interest 320i in the source image 320, such as between the first and second entities 320A and 320B, next to the first entity 320B, behind both the first and second entities 320A and 320B, or the like.

At operation 1104, the method 1100 may include generating, for each of the one or more target entities, a relative skeletal map using the one or more masked relevant images. The method 1100 includes generating, for each of the entities of interest 320i, the relative skeletal map 520 using the set of masked relevant images 510M. The relative skeletal map 520 may include information pertaining to the physical aspects of the entity of interest 320i. In an embodiment, at operation 1104, the method 1100 includes using ML models to compare the physical aspects of the entity of interest 320i with the physical aspects of at least one entity in the set of masked relevant images 510M, and the source image 320. In an embodiment, at operation 1104, the comparing of the physical aspects may include comparing physical features such as, but not limited to, a height, a body shape, or a face shape of the entities such as, but not limited to, the entities of interest 320i and the first and second entities 320A and 320B appearing in the source image.

Based on the comparison, the method 1100 further includes determining a set of relative features for each of the entities of interest 320i with respect to at least one entity (e.g., the first entity 320A or the second entity 320B) appearing in the source image 320. The set of relative features may include physical features such as, but not limited to, height, body-type, and body structure of the entity of interest 320i with respect to the one or all of the first and second entities 320A and 320B in the source image 320. In an embodiment, the method 1100 includes comparing the entity of interest 320i and the first and second entities 320A and 320B to a common entity for generating the set of relative features especially in cases where the entity of interest 320i and any of the first and second entities 320A and 320B are not found in the same image. That is, the method 1100 includes generating the set of relative features by generating sub relative feature sets of the entity of interest and the first and second entities 320A and 320B with the common entity. The sub relative features sets may be compared to generate the relative feature map for the entity of interest 320i.

At operation 1106, the method 1100 may include generating, for the source image, a feature map comprising information corresponding to physical aspects of the source entities appearing in the source image, and aspects corresponding to a scene identified in the source image. The method 1100 includes generating, for the source image 320, the aesthetic feature map 530 including information related to the physical aspects of the entities appearing in the source image 320, and the aspects related to the scene 100S. The information related to the physical aspects of the first and second entities 320A and 320B, and the aspects related to the scene 100S include attributes of the entities and the source image which may need to be considered for the generation of the recreated image 320N. FIG. 12 includes a table 1200 describing an exemplary non-exhaustive list of attributes of the entities. Similarly, FIG. 13 includes a table 1300 describing an exemplary non-exhaustive list of the aspects related to the scene 100S.

In an embodiment, at operation 1106, the method 1100 further includes using ML models to determine the physical aspects of the first and second entities 320A and 320B in the source image 320 and features related to a composition of the source image 320. The features related to the composition of the source image 320 may include, but not be limited to, light, ambience, perspective, angle, shadows or the like. The physical aspects include features of the first and second entities 320A and 320B in the source image 320 related to a facial expression, a pose, a posture, a hair style, an attire of the first and second entities 320A and 320B in the source image 320. The features related to the composition may include, but not be limited to, features related to a weather, a lighting, and a theme of the source image 320. An exemplary non-exhaustive list of the aspects related to the scene 100S is described with reference to FIG. 13.

In an embodiment, the method 1100 includes training the ML models to determine the physical aspects. The training is performed using an intermediate layer output of a pre-trained trainer ML model. The method 1100 includes pre-training the trainer ML model using a set of annotated images and marked corresponding target features.

At operation 1108, the method 1100 may include generating an image reconstruction map, based on the feature map of the source image and at least one of the relative skeletal maps. The method 1100 includes generating, the image reconstruction map 950 based on the aesthetic feature map 530 of the source image 320, and at least one of the relative skeletal maps 520. At operation 1110, the method 1100 includes generating, based on the image reconstruction map, a modified source image comprising the one or more target entities. The method 1110 includes recreating, based on the image reconstruction map 950, the source image 320 added with the one or more entities of interest 320i. In an embodiment, at operation 1110, the method 1100 further includes receiving the input from the user of the device 150 regarding the location in the source image 320 where the entities of interest 320i are to be placed when adding to the source image 320. In an embodiment, the method 1100 includes determining the location based on the relative skeletal map 520 and the aesthetic feature map 530.

The electronic device 310 and method 1100 of the present disclosure provide ML models to add an entity of interest 320i to an existing image. The method and system of the present disclosure may be integrated with generative artificial intelligence (AI) image editing applications. The method and system of the present disclosure provide for an image generator to insert a target entity (e.g., entity of interest 320i) into a source image 320, in line with user and source image requirements. The method and system of the present disclosure provide for generation of intrinsic and relative skeletal feature maps for both the target entity and a reference entity. The method and system of the present disclosure provide for determination of an optimal position and pose of the target entity within the source image while maintaining the aesthetic integrity of the original source image.

That is, the method 1100 is generally directed at automatically adding a person (e.g., entity of interest 320i) to a photo with a suitable pose and aesthetically good position, expression, attire in image. The present disclosure provides a method to generate a realistic output image that seamlessly inserts a target entity into a source image with a suitable pose, position, expression, and attire that match the context and style of the source image.

The system and method of the present disclosure analyze the selected image and analyze the feature of the person to be added (e.g., the father of the user). Using past image information, the system and method of the present disclosure predicts how the father looks with relation to other people (e.g., relative height, weight, posture, or the like). In addition, the system and method of the present disclosure also analyze the selected photo (e.g., source image 320) to determine its intrinsic features (e.g., facial features, hair style, expression, or the like) and artistic features (e.g., pose, scene, lighting, or the like). Using a combination of both the analyses, the system and method of the present disclosure may determine the best possible way of adding the father to the selected photo and may use an image generator to output the same.

That is, the system and method of the present disclosure may only need minimal to no manual intervention and may obviate the need to select a representative image. A user may capture an image and/or select an existing image and a give a direct prompt/command such as, but not limited to, “Add John to this”, or “Please add mom and dad to this photo, dad closer to me and mom closer to my husband”, or the like.

The present disclosure may achieve a deep, aesthetic understanding of the image to ensure that the generated image has the missing person added in alignment to the features of the source image such as, but not limited to, location, pose, time of day, physical features of person, outfits, expressions, or the like. As a result, the system and method of the present disclosure avoid a need for a significant amount of manual image editing.

While specific language has been used to describe the disclosure, any limitations arising on account of the same are not intended. As would be apparent to a person in the art, various working modifications may be made to the method in order to implement the present disclosure concept as taught herein.

The drawings and the forgoing description give examples of embodiments. Those skilled in the art may appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any components that may cause any benefit, advantage, or solution to occur or become more pronounced are not to be construed as a critical, required, or essential feature or component of any or all the claims.

According to an embodiment of the disclosure, a method for adding one or more target entities to a source image may be provided. According to an embodiment of the disclosure, the method may include generating one or more masked relevant images by masking-out irrelevant entities from plurality of the relevant images. According to an embodiment of the disclosure, the plurality of relevant images may comprise at least one of the one or more target entities, or the one or more irrelevant entities not corresponding to source entities appearing in the source image. According to an embodiment of the disclosure, the method may include generating, for each of the one or more target entities, a relative skeletal map using the one or more masked relevant images. According to an embodiment of the disclosure, the relative skeletal map may comprise information pertaining to physical aspects of a corresponding target entity. According to an embodiment of the disclosure, the method may include generating, for the source image, a feature map comprising information corresponding to physical aspects of the source entities appearing in the source image, and aspects corresponding to a scene identified in the source image. According to an embodiment of the disclosure, the method may include generating an image reconstruction map, based on the feature map of the source image and at least one of the relative skeletal maps. According to an embodiment of the disclosure, the method may include generating, based on the image reconstruction map, a modified source image comprising the one or more target entities.

According to an embodiment of the disclosure, the generating of the one or more masked relevant images may include retrieving the plurality of relevant images from available images, associated with at least one device having access to an electronic device. According to an embodiment of the disclosure, the plurality of relevant images may correspond to at least one entity of at least one of the one or more target entities or the source entities appearing in the source image.

According to an embodiment of the disclosure, the retrieving of the plurality of relevant images may include receiving an input from a user. According to an embodiment of the disclosure, the input may comprise at least one of an identification of the target entity or an identification of a reference image including the target entity.

According to an embodiment of the disclosure, the receiving of the input may include receiving the reference image as the input from the user.

According to an embodiment of the disclosure, the method may include receiving an input from a user. According to an embodiment of the disclosure, the input may include information corresponding to at least one of: an aspect corresponding to at least one of the one or more target entities; or an aspect corresponding to the source image.

According to an embodiment of the disclosure, the generating of the relative skeletal map may include using one or more machine learning (ML) models. According to an embodiment of the disclosure, the generating of the relative skeletal map may include comparing the physical aspects of the corresponding target entity with physical aspects of at least one entity in the one or more masked relevant images and the source image. According to an embodiment of the disclosure, the generating of the relative skeletal map may include determining, based on the comparing, one or more relative features of the corresponding target entity with respect to at least one source entity appearing in the source image.

According to an embodiment of the disclosure, the comparing of the physical aspects may include comparing physical features of the corresponding target entity with physical features of the at least one entity in the one or more masked relevant images and the source image. According to an embodiment of the disclosure, the physical features may comprise at least one of a height, a body shape, or a face shape of the at least one entity in the one or more masked relevant images and the source image.

According to an embodiment of the disclosure, the generating of the feature map may include determining, using one or more machine learning (ML) models, physical aspects of the source entities in the source image and features corresponding to a composition of the source image.

According to an embodiment of the disclosure, the one or more ML models may be trained for determining the physical aspects of the source entities in the source image and determining the features corresponding to the composition of the source image. According to an embodiment of the disclosure, the training may have been performed using an intermediate layer output of a pre-trained trainer ML model. According to an embodiment of the disclosure, the pre-trained trainer ML model may have been pre-trained using annotated images and marked corresponding target features.

According to an embodiment of the disclosure, the determining of the physical aspects may include determining features of the source entities in the source image. According to an embodiment of the disclosure, the features may correspond to at least one of a facial expression, a pose, a posture, a hair style, or an attire of the source entities in the source image. According to an embodiment of the disclosure, the determining of the features corresponding to the composition may include determining the features corresponding to at least one of a weather, a lighting, or a theme of the source image.

According to an embodiment of the disclosure, the generating of the modified source image may include receiving an input from a user regarding a location of the source entities in the source image for adding the one or more target entities.

According to an embodiment of the disclosure, the generating of the modified source image may include determining a location of the source entities in the source image for adding the one or more target entities, based on at least one of the relative skeletal maps or the feature map of the source image.

According to an embodiment of the disclosure, the generating of the one or more masked relevant images may include identifying the irrelevant entities in the plurality of relevant images using one or more machine learning (ML) models. According to an embodiment of the disclosure, the generating of the one or more masked relevant images may include masking the irrelevant entities in the plurality of relevant images using one or more machine learning (ML) models.

According to an embodiment of the disclosure, the ML models are trained by using sample data, for identifying and masking the irrelevant entities in the plurality of relevant images.

According to an embodiment of the disclosure, an electronic device for adding one or more target entities to a source image may be provided. According to an embodiment of the disclosure, electronic device may include one or more processors comprising processing circuitry; and memory storing instructions. According to an embodiment of the disclosure, the instructions, when executed by the one or more processors individually or collectively, may cause the electronic device to generate one or more masked relevant images by masking-out irrelevant entities from plurality of relevant images. According to an embodiment of the disclosure, the plurality of relevant images may include at least one of the one or more target entities, or the one or more irrelevant entities not corresponding to source entities appearing in the source image. According to an embodiment of the disclosure, the instructions, when executed by the one or more processors individually or collectively, may cause the electronic device to generate, for each of the one or more target entities of interest, a relative skeletal map using the one or more masked relevant images. According to an embodiment of the disclosure, the relative skeletal map may comprise information pertaining to physical aspects of a corresponding target entity. According to an embodiment of the disclosure, the instructions, when executed by the one or more processors individually or collectively, may cause the electronic device to generate, for the source image, an aesthetic feature map comprising information corresponding to physical aspects of the source entities appearing in the source image, and aspects corresponding to a scene identified in the source image. According to an embodiment of the disclosure, the instructions, when executed by the one or more processors individually or collectively, may cause the electronic device to generate, an image reconstruction map based on the aesthetic feature map of the source image, and at least one of the relative skeletal maps. According to an embodiment of the disclosure, the instructions, when executed by the one or more processors individually or collectively, may cause the electronic device to generate, based on the image reconstruction map, a modified source image comprising the one or more target entities.

According to an embodiment of the disclosure, the instructions, when executed by the one or more processors individually or collectively, may cause the electronic device to compare, using one or more machine learning (ML) models, the physical aspects of the corresponding target entity with physical aspects of at least one entity in the one or more masked relevant images, and the source image. According to an embodiment of the disclosure, the instructions, when executed by the one or more processors individually or collectively, may cause the electronic device to determine, using one or more machine learning (ML) models, based on the comparison, one or more relative features of the corresponding target entity with respect to at least one entity appearing in the source image.

According to an embodiment of the disclosure, the instructions, when executed by the one or more processors individually or collectively, may cause the electronic device to determine, using one or more machine learning (ML) models, physical aspects of the source entities in the source image and features corresponding to a composition of the source image.

According to an embodiment of the disclosure, the instructions, when executed by the one or more processors individually or collectively, may cause the electronic device to determine a location of the source entities in the source image for adding the one or more target entities, based on at least one of the relative skeletal maps According to an embodiment of the disclosure, the instructions, when executed by the one or more processors individually or collectively, may cause the electronic device to identify the irrelevant entities in the plurality of relevant images, using one or more machine learning (ML) models. According to an embodiment of the disclosure, the instructions, when executed by the one or more processors individually or collectively, may cause the electronic device to mask the irrelevant entities in the plurality of relevant images, using one or more machine learning (ML) models.

According to an embodiment of the disclosure, a computer-readable storage medium storing instructions may be provided. According to an embodiment of the disclosure, the computer-readable storage medium storing instructions that, when executed by at least one processor, may cause the at least one processor to generate one or more masked relevant images by masking-out irrelevant entities from plurality of relevant images, According to an embodiment of the disclosure, the plurality of relevant images may comprise at least one of the one or more target entities, or the one or more irrelevant entities not corresponding to source entities appearing in the source image. According to an embodiment of the disclosure, the computer-readable storage medium storing instructions that, when executed by at least one processor, may cause the at least one processor to generate, for each of the one or more target entities of interest, a relative skeletal map using the one or more masked relevant images. According to an embodiment of the disclosure, the relative skeletal map may comprise information pertaining to physical aspects of a corresponding target entity. According to an embodiment of the disclosure, the computer-readable storage medium storing instructions that, when executed by at least one processor, may cause the at least one processor to generate, for the source image, an aesthetic feature map comprising information corresponding to physical aspects of the source entities appearing in the source image, and aspects corresponding to a scene identified in the source image. According to an embodiment of the disclosure, the computer-readable storage medium storing instructions that, when executed by at least one processor, may cause the at least one processor to generate, an image reconstruction map based on the aesthetic feature map of the source image, and at least one of the relative skeletal maps. According to an embodiment of the disclosure, the computer-readable storage medium storing instructions that, when executed by at least one processor, may cause the at least one processor to generate, based on the image reconstruction map, a modified source image comprising the one or more target entities.

A method for adding one or more entities of interest to a source image includes generating, from a plurality of relevant images, one or more masked relevant images by masking-out irrelevant entities from the plurality of relevant images, generating, for each of the one or more entities of interest, a relative skeletal map using the one or more masked relevant images, generating, for the source image, a feature map including information corresponding to physical aspects of the entities appearing in the source image, and aspects corresponding to a scene captured in the source image, generating, an image reconstruction map based on the feature map of the source image, and at least one of the relative skeletal maps, and recreating, based on the image reconstruction map, a modified source image including the one or more entities of interest. The plurality of relevant images include images corresponding to at least one of the one or more entities of interest. The irrelevant entities do not correspond to entities appearing in the source image and the one or more entities of interest. The relative skeletal map includes information pertaining to physical aspects of a corresponding entity of interest.

A system for adding one or more entities of interest to a source image includes one or more processors including processing circuitry, and a memory storing instructions. The instructions, when executed by the one or more processors individually or collectively, cause the system to generate, from a plurality of relevant images, a one or more masked relevant images by masking-out irrelevant entities from the plurality of relevant images, generate, for each of the one or more entities of interest, a relative skeletal map using the one or more masked relevant images, generate, for the source image, an aesthetic feature map including information corresponding to physical aspects of the entities appearing in the source image, and aspects corresponding to a scene captured in the source image, generate, an image reconstruction map based on the aesthetic feature map of the source image, and at least one of the relative skeletal map, and recreate, based on the image reconstruction map, a modified source image including the one or more entities of interest. The plurality of relevant images include images corresponding to at least one of the one or more entities of interest. The irrelevant entities do not correspond to entities appearing in the source image and the one or more entities of interest. The relative skeletal map includes information pertaining to physical aspects of a corresponding entity of interest.

A method for adding one or more entities of interest to a source image includes generating, from a reference image, the one or more entities of interest by performing segmentation of the reference image and masking the one or more entities of interest in the segmented reference image; generating, from a plurality of relevant images, one or more masked relevant images by masking-out irrelevant entities from the plurality of relevant images, generating, for each of the one or more entities of interest, a relative skeletal map using the one or more masked relevant images, generating, for the source image, a feature map including information corresponding to physical aspects of the entities appearing in the source image, and aspects corresponding to a scene captured in the source image, generating, an image reconstruction map based on the feature map of the source image, and at least one of the relative skeletal maps, and recreating, based on the image reconstruction map, a modified source image including the one or more entities of interest. The plurality of relevant images include images corresponding to at least one of the one or more entities of interest. The irrelevant entities do not correspond to entities appearing in the source image and the one or more entities of interest. The relative skeletal map includes information pertaining to physical aspects of a corresponding entity of interest.

What is claimed is:

1. A method for adding one or more target entities to a source image, the method comprising:
generating one or more masked relevant images by masking-out irrelevant entities from plurality of relevant images,
wherein the plurality of relevant images comprises at least one of the one or more target entities, or one or more irrelevant entities not corresponding to source entities appearing in the source image;
generating, for each of the one or more target entities, a relative skeletal map using the one or more masked relevant images,
wherein the relative skeletal map comprises information pertaining to physical aspects of a corresponding target entity;
generating, for the source image, a feature map comprising information corresponding to physical aspects of the source entities appearing in the source image, and aspects corresponding to a scene identified in the source image;
generating an image reconstruction map, based on the feature map of the source image and at least one of the relative skeletal maps; and
generating, based on the image reconstruction map, a modified source image comprising the one or more target entities.

2. The method of claim 1, wherein the generating of the one or more masked relevant images comprises:
retrieving the plurality of relevant images from available images associated with at least one device having access to an electronic device,
wherein the plurality of relevant images correspond to at least one entity of at least one of the one or more target entities or the source entities appearing in the source image.

3. The method of claim 2, wherein the retrieving of the plurality of relevant images comprises:
receiving an input from a user,
wherein the input comprises at least one of an identification of the target entity or an identification of a reference image including the target entity.

4. The method of claim 1, further comprising:
receiving an input from a user,
wherein the input comprises information corresponding to at least one of:
an aspect corresponding to at least one of the one or more target entities; or
an aspect corresponding to the source image.

5. The method of claim 1, wherein the generating of the relative skeletal map comprises using one or more machine learning (ML) models for:
comparing the physical aspects of the corresponding target entity with physical aspects of at least one entity in the one or more masked relevant images and the source image; and
determining, based on the comparing, one or more relative features of the corresponding target entity with respect to at least one source entity appearing in the source image.

6. The method of claim 5, wherein the comparing of the physical aspects comprises:
comparing physical features of the corresponding target entity with physical features of the at least one entity in the one or more masked relevant images and the source image,
wherein the physical features comprise at least one of a height, a body shape, or a face shape of the at least one entity in the one or more masked relevant images and the source image.

7. The method of claim 1, wherein the generating of the feature map comprises:
determining, using one or more machine learning (ML) models, the physical aspects of the source entities in the source image and features corresponding to a composition of the source image.

8. The method of claim 7, wherein the one or more ML models are trained for determining the physical aspects of the source entities in the source image and determining the features corresponding to the composition of the source image,
wherein the training has been performed using an intermediate layer output of a pre-trained trainer ML model,
wherein the pre-trained trainer ML model has been pre-trained using annotated images and marked corresponding target features.

9. The method of claim 8, wherein the determining of the physical aspects comprises determining features of the source entities in the source image,
wherein the features correspond to at least one of a facial expression, a pose, a posture, a hair style, or an attire of the source entities in the source image, and
wherein the determining of the features corresponding to the composition comprises determining the features corresponding to at least one of a weather, a lighting, or a theme of the source image.

10. The method of claim 1, wherein the generating of the modified source image comprises:
receiving an input from a user regarding a location of the source entities in the source image for adding the one or more target entities.

11. The method of claim 1, wherein the generating of the modified source image comprises:
determining a location of the source entities in the source image for adding the one or more target entities, based on at least one of the relative skeletal maps or the feature map of the source image.

12. The method of claim 1, wherein the generating of the one or more masked relevant images comprises:
identifying and masking the irrelevant entities in the plurality of relevant images using one or more machine learning (ML) models.

13. The method of claim 12, wherein the one or more ML models are trained by:
using sample data, for identifying and masking the irrelevant entities in the plurality of relevant images.

14. An electronic device for adding one or more target entities to a source image, the electronic device comprising:
one or more processors comprising processing circuitry; and
memory storing instructions,
wherein the instructions, when executed by the one or more processors individually or collectively, cause the electronic device to:
generate one or more masked relevant images by masking-out irrelevant entities from plurality of relevant images,
wherein the plurality of relevant images comprises at least one of the one or more target entities, or one or more irrelevant entities not corresponding to source entities appearing in the source image;
generate, for each of the one or more target entities of interest, a relative skeletal map using the one or more masked relevant images,
wherein the relative skeletal map comprises information pertaining to physical aspects of a corresponding target entity;
generate, for the source image, an aesthetic feature map comprising information corresponding to physical aspects of the source entities appearing in the source image, and aspects corresponding to a scene identified in the source image;
generate, an image reconstruction map based on the aesthetic feature map of the source image, and at least one of the relative skeletal maps; and
generate, based on the image reconstruction map, a modified source image comprising the one or more target entities.

15. The electronic device of claim 14, wherein the instructions, when executed by the one or more processors individually or collectively, cause the electronic device to:
retrieve the plurality of relevant images from available images associated with at least one device having access to the electronic device,
wherein the plurality of relevant images correspond to at least one entity of at least one of the one or more target entities or the source entities appearing in the source image.

16. The electronic device of claim 14, wherein the instructions, when executed by the one or more processors individually or collectively, cause the electronic device to:
compare, using one or more machine learning (ML) models, the physical aspects of the corresponding target entity with physical aspects of at least one entity in the one or more masked relevant images, and the source image; and
determine, using the one or more ML models, based on the comparison, one or more relative features of the corresponding target entity with respect to at least one entity appearing in the source image.

17. The electronic device of claim 14, wherein the instructions, when executed by the one or more processors individually or collectively, cause the electronic device to:
determine, using one or more machine learning (ML) models, the physical aspects of the source entities in the source image and features corresponding to a composition of the source image.

18. The electronic device of claim 14, wherein the instructions, when executed by the one or more processors individually or collectively, cause the electronic device to:
determine a location of the source entities in the source image for adding the one or more target entities, based on at least one of the relative skeletal maps or the aesthetic feature map of the source image.

19. The electronic device of claim 14, wherein the instructions, when executed by the one or more processors individually or collectively, cause the electronic device to:
identify and mask the irrelevant entities in the plurality of relevant images, using one or more machine learning (ML) models.

20. A non-transitory computer-readable storage medium storing instruction that, when executed by at least one processor, cause the at least one processor to:
generate one or more masked relevant images by masking-out irrelevant entities from plurality of relevant images,
wherein the plurality of relevant images comprises at least one of the one or more target entities, or one or more irrelevant entities not corresponding to source entities appearing in a source image;
generate, for each of the one or more target entities of interest, a relative skeletal map using the one or more masked relevant images,
wherein the relative skeletal map comprises information pertaining to physical aspects of a corresponding target entity;
generate, for the source image, an aesthetic feature map comprising information corresponding to physical aspects of the source entities appearing in the source image, and aspects corresponding to a scene identified in the source image;
generate, an image reconstruction map based on the aesthetic feature map of the source image, and at least one of the relative skeletal maps; and
generate, based on the image reconstruction map, a modified source image comprising the one or more target entities.
